(19) United States
(12) Patent Application Publication
(10) Pub. No.: US 2020/0246112 A1
(43) Pub. Date: Aug. 6, 2020

(54) 3-DIMENSIONAL STRIP FOR STRIPPING TOOTH AND TOOTH STRIPPING DEVICE INCLUDING THE SAME

(71) Applicant: Kyungsik LEE, Seoul (KR)

(72) Inventor: Kyungsik LEE, Seoul (KR)

(21) Appl. No.: 16/648,112

(22) PCT Filed: Mar. 15, 2018
(86) PCT No.: PCT/KR2018/003039

§ 371 Date: Mar. 17, 2020

(30) Foreign Application Priority Data
Sep. 18, 2017 (KR) 10-2017-0119486

(51) Int. Cl. A61C 3/06; A61C 3/025

(52) U.S. Cl. CPC A61C 3/06; A61C 3/025

(57) ABSTRACT

A 3-dimentional strip for stripping a tooth is provided. Some or whole of at least one side of both sides includes a abrasive face to abrade an interdental area, an upper portion includes a predetermined thickness along a longitudinal direction, and a lower portion includes a thickness decreased toward an end of the longitudinal direction and increased toward the other end of the longitudinal direction. The thickness on the other end is greater than the thickness of the upper portion.

### BACKGROUND

### Technical Field

The present invention relates to a strip for stripping a tooth and more particularly, to a strip for stripping a tooth and a tooth stripping device including the same.

### Description of the Related Art

Orthodontic treatment includes a process of interdental removal or stripping. The process is a treatment technique that reduces the widths of the teeth by gritting adjacent surfaces where the teeth are in contact with each other. This stripping has been done for a long time and has been a method commonly used in many orthodontic treatments since the American Orthodontic Society in the early 2000s formally recognized the method of stripping teeth as a safe orthodontic technique without side effects.

When such interdental stripping or tooth stripping is required, there are various cases, such as to provide a space for arranging the teeth, to eliminate a void space (black triangle) between the teeth, to improve an occlusal relationship between upper and lower front teeth, to reduce the teeth, and to increase the stability after orthodontic treatment.

Since a neural distribution is not present in a structure of an outermost enamel layer of the tooth structure, interdental stripping needs to be treated so as to be limited to only this part. The outermost enamel layer is usually about 0.5 mm per side of the tooth, but depends on the size of the tooth.

However, when a tooth is stripped using a conventional tooth stripping device, it is not easy to accurately strip the tooth at only a desired position due to the characteristics of the shapes and the arrangement of the teeth. This can also be seen in ‘orthodontic strip’ of Korean Patent Registration No. 1583628 as the prior art, wherein a ‘polishing blade’ used for tooth stripping is manufactured to have a uniform thickness and shape throughout. Therefore, in the case of using such a conventional tooth stripping device, there is a disadvantage in that a distance D is widened up and down because the degree of stripping of the adjacent teeth T1 and T2 is varied as shown in FIG. 1. As a result, such teeth stripping is accompanied by unnecessary tooth stripping and results in aesthetic problems.

Therefore, the stripping of the tooth, particularly the interdental area, has a problem that excessive stripping of undesired portions or high-speed stripping of desired portions are performed unlike the intention of the operator.

### SUMMARY

The present invention is derived to solve the above problems, and a first object of the present invention is to provide a 3-dimensional strip for stripping a tooth and a tooth stripping device including the same capable of precisely stripping only a desired tooth portion of an operator.

A second object of the present invention is to provide a 3-dimensional strip for stripping teeth and a tooth stripping device capable of easily stripping a tooth with a uniform thickness along an outline of the tooth.

A third object of the present invention is to provide a 3-dimensional strip for stripping teeth and a tooth stripping device capable of adjusting an amount of tooth stripping or a stripping thickness by using a specific part in a longitudinal direction by an operator depending on a distance between teeth (interdental degree).

A fourth object of the present invention is to provide a 3-dimensional strip for stripping teeth and a tooth stripping device capable of stripping a tooth by considering tooth aesthetics after stripping operation when an operator strips the tooth.

The objects of the present invention may be achieved by providing a 3-dimentional strip for stripping a tooth, wherein some or whole of at least one side of both sides has an abrasive face to abrade an interdental area, an upper portion has a certain thickness along a longitudinal direction, and a lower portion has a thickness decreased toward an end of the longitudinal direction and increased toward the other end of the longitudinal direction, wherein the thickness on the other end is greater than that of the upper portion.

The upper portion and the lower portion of the 3-dimentional strip for stripping the tooth may be connected to each other continuously in a height direction and the lower portion may be formed up to ¼ to ¾ of the entire height from a lower end thereof.

A longitudinal section of the other end of the 3-dimentional strip for stripping the tooth may have a concavely curved outline.

A thickness of the upper portion of the 3-dimentional strip for stripping the tooth may be 0.05 mm to 0.2 mm and a thickness of the lower portion may be 0.05 mm to 0.3 mm at the other end.

Meanwhile, the objects of the present invention may be achieved by providing a tooth stripping device comprising: a 3-dimentional strip for stripping a tooth, wherein some or whole of at least one side of both sides has an abrasive face to abrade an interdental area, an upper portion has a certain thickness along a longitudinal direction, and a lower portion has a thickness decreased toward an end of the longitudinal direction and increased toward the other end of the longitudinal direction, wherein the thickness on the other end is greater than that of the upper portion; a strip holder coupled to both ends of the strip for stripping the tooth; and a handpiece coupled to one end of the strip holder.

According to the embodiment of the present invention, it is possible to precisely strip only a desired tooth portion of an operator.

In addition, since the tooth portion may be easily stripped with a uniform thickness along an outline of the tooth, it is possible to maintain a natural tooth shape as it is.

Further, it is possible to adjust an amount of tooth stripping or a stripping thickness by selectively using a specific part in a longitudinal direction by an operator depending on a distance between teeth.

Furthermore, it is possible to strip a tooth portion by considering tooth aesthetics after stripping operation when an operator strips the tooth.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating before and after stripping (from left to right) when interdental stripping is performed using a conventional tooth stripping device;

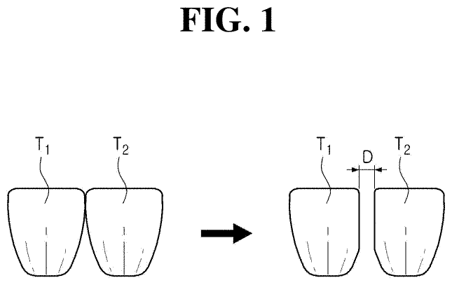

FIG. 2 is a side view illustrating one side of a 3-dimensional strip for stripping a tooth according to an embodiment of the present invention;

FIG. 3 is a cross-sectional view illustrating a longitudinal section in an AA direction;

FIG. 4 is a cross-sectional view illustrating a longitudinal section in a BB direction;

FIG. 5 is a plan view illustrating a 3-dimensional strip for stripping a tooth according to an embodiment of the present invention, which is viewed from top to bottom;

FIG. 6 is a view illustrating a perspective view of a tooth stripping device provided with a 3-dimensional strip for stripping a tooth according to an embodiment of the present invention; and

FIG. 7 is a view illustrating before and after stripping (from left to right) when interdental stripping is performed using a 3-dimensional strip for stripping a tooth according to an embodiment of the present invention.

### DETAILED DESCRIPTION

Hereinafter, embodiments of the present invention will be described in detail with reference to the accompanying drawings and the contents disclosed in the accompanying drawings, but the present invention is not limited or restricted to the embodiments.

Various modifications may be made to embodiments to be described below. Embodiments to be described below are not intended to be limited to aspects and should be understood to include all modifications, equivalents, and substitutes thereof.

Terminologies used in the embodiments are used only to describe specific embodiments, and are not intended to limit the embodiments. A singular form may include a plural form if there is no clearly opposite meaning in the context. Further, in the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Meanwhile, in describing the present invention, detailed description of associated known function or constitutions will be omitted if it is determined that they unnecessarily make the gist of the present invention unclear. Terminologies used herein are a terminologies used to properly express embodiments of the present invention, which may vary according to a user, an operator's intention, or customs in the art to which the present invention pertains. Accordingly, definitions of the terminologies need to be described based on contents throughout this specification.

In addition, in the description with reference to the accompanying drawings, like components regardless of reference numerals designate like reference numerals and a duplicated description thereof will be omitted. In describing the embodiments, a detailed description of related known technologies will be omitted if it is determined that they unnecessarily make the gist of the embodiments unclear.

3-Dimentional Strip for Stripping Tooth and Tooth Stripping Device

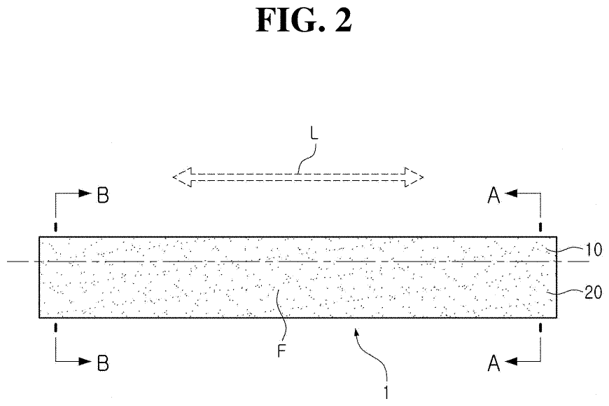

A 3-dimensional strip for stripping the tooth of the present invention serves to enable even stripping of a tooth surface by forming different thicknesses in a longitudinal direction and a height direction. Hereinafter, an embodiment of the present invention will be described in detail with reference to FIGS. 2 to 7.

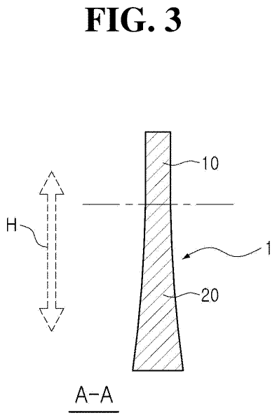

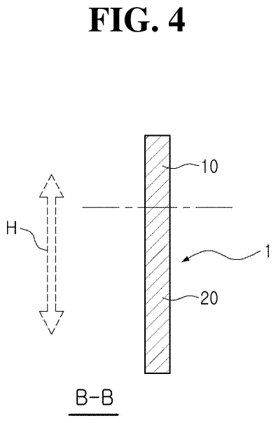

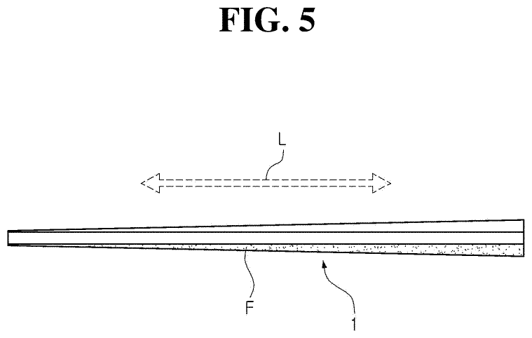

FIG. 2 is a side view illustrating one side of a 3-dimensional strip for stripping a tooth according to an embodiment of the present invention, FIG. 3 is a cross-sectional view illustrating a longitudinal section in an AA direction, FIG. 4 is a cross-sectional view illustrating a longitudinal section in a BB direction, and FIG. 5 is a plan view illustrating the 3-dimensional strip for stripping the tooth, which is viewed from top to bottom. As illustrated in FIG. 2, the 3-dimensional strip for stripping the tooth according to the embodiment is formed to be elongated in a longitudinal direction L and formed with a small thickness and thus manufactured so as to have flexibility. At least one of both surfaces (or both sides) is formed as an abrasive face F for interdental abrading.

The 3-dimensional strip for stripping the tooth may be made of stainless steel, or may also be made of metal or synthetic resin having similar strength and durability thereto. In particular, the abrasive face F may be provided with a diamond-tipped abrasive material or an abrasive material such as aluminum oxide.

The 3-dimensional strip 1 for stripping the tooth is configured to vary in thickness in a longitudinal direction L and a height direction H, as illustrated in FIGS. 2 to 5. That is, in a cross section in an AA direction, a thickness of a lower portion 20 is larger than that of an upper portion 10, and in a cross section in a BB direction, the thickness of the lower portion 20 is equal to that of the upper portion 10. In the case of the present embodiment, a left side of the strip 1 illustrated in FIG. 2 has a lower thickness of the lower portion 20 and the lower portion 20 has a higher thickness than the left side toward the right side. Accordingly, in a plan view illustrated in FIG. 5, it can be seen that an upper surface of the upper portion 10 is shown in a rectangular shape and overlaps the edge of the lower portion 20 on the left side, but the edge of the lower portion 20 is larger than the upper surface of the upper portion 10 toward the right side.

Here, the upper portion 10 and the lower portion 20 may be divided based on a portion whose thickness is constant in the height direction H and starts to be changed as a reference line. The portion having a thin and constant thickness may be defined as the upper portion 10 and the portion starting to be changed in thickness may be defined as the lower portion 20. Since the strip 1 has the same thickness of the upper portion 10 and the lower portion 20 at one end in the longitudinal direction, the reference of the upper portion 10 and the lower portion 20 may be divided by determining a reference point at which the thickness is changed at the other end in the longitudinal direction and setting a virtual reference line in parallel with the longitudinal direction at the determined reference point. In the present embodiment, in FIGS. 2 to 4, a dashed-dotted line in a transverse direction serves as a reference line for dividing the upper portion 10 and the lower portion 20.

The upper portion 10 and the lower portion 20 of the 3-dimensional strip 1 for stripping the tooth are configured to be connected to each other in a height direction. The lower portion 20 may be modified and designed according to an outline of the tooth surface, but is preferably formed within ¼ to ¾ of the entire height from the lower portion, and the lower edge of the lower portion 20 may be smoothly rounded unlike those illustrated in FIGS. 3 and 4, and particularly, the lower surface of the lower portion 20 may also be rounded.

It is preferable that the longitudinal section of the other end of the 3-dimensional strip 1 for stripping the tooth has a concavely curved outline. Considering the thickness of the 3-dimensional strip 1 for stripping the tooth, the longitudinal section may be a rectangular section in the BB direction and a trapezoidal section in the AA direction, but two sides belonging to both surfaces in the AA direction of the 3-dimensional strip 1 for stripping the tooth may be an inwardly concave curve. As a result, it is preferable that both surfaces of the strip 1 are configured to be continuously changed while being changed from a planar surface to a curved surface toward one direction of the longitudinal direction L.

Here, the thickness of the upper portion 10 of the 3-dimensional strip 1 for stripping the tooth may be formed from 0.05 mm to 0.2 mm, the thickness of the lower portion 20 may be formed from 0.05 mm to 0.3 mm at the other end.

When the operator uses the 3-dimensional strip 1 for stripping the tooth of the present embodiment, the operator may easily insert a longitudinal end with a entirely thin thickness into an interdental area and determine the insertion degree in consideration of a with between the patient's teeth. In addition, the operator uses the abrasive face F of the curved surface similar to the tooth surface even after insertion to strip an enamel in a uniform thickness.

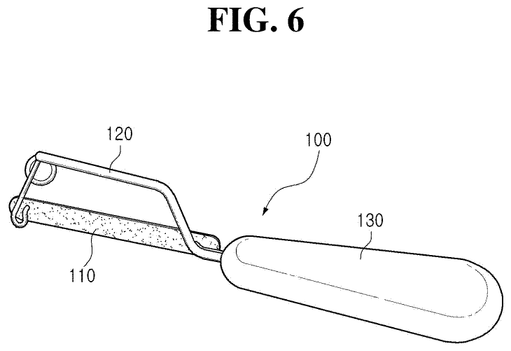

FIG. 6 is a view illustrating a perspective view of a tooth stripping device provided with a 3-dimensional strip for stripping a tooth according to an embodiment of the present invention. As illustrated in FIG. 5, a tooth stripping device 100 has a strip holder 120 coupled and fixed to both ends of a 3-dimensional strip 110 for stripping a tooth according to the present embodiment, and one end of the strip holder 120 is configured to be coupled to a handpiece 130.

Here, the strip holder 120 may be formed of a wire having rigidity. In particular, the strip holder 120 may be bent at one end and the other end of the 3-dimensional strip 110 for stripping the tooth, respectively, and may be fixed by drilling a hole in the 3-dimensional strip 110 for stripping the tooth and inserting one end of the wire into the hole. Since the wire end on the handpiece 130 side is coupled to the handpiece 130, a separate wire is added to the wire in parallel by welding and the like and one end of the separate wire is inserted into the hole, so that both the wires may be fastened to both ends of the 3-dimensional strip 110 for stripping the tooth.

The tooth stripping device 100 is illustrative and the strip holder 120 may be a steel stick other than a wire, or may also be made of a synthetic resin material having excellent rigidity and durability. The handpiece 130 of the present embodiment may also be formed of a synthetic resin material, but may be a metal, and its shape may also be formed in various shapes. Like the present embodiment, the handpiece 130 may be simply formed in a straight shape, but may be manufactured in a form having a larger curve enough to be comfortably held by the operator.

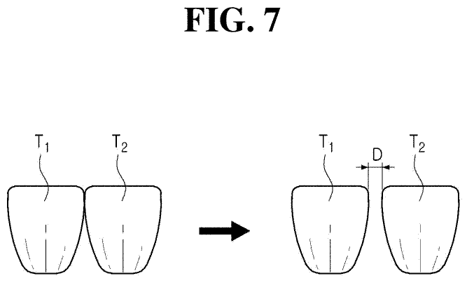

FIG. 7 is a view illustrating before and after interdental stripping (from left to right) by using the tooth stripping device 100 which is the present embodiment. When a distance D between the adjacent teeth T1 and T2 is to be set, the strips 1 and 110 for stripping the tooth of the present embodiment are interposed between the adjacent teeth T1 and T2 to strip the enamel of the tooth, thereby enabling even stripping as illustrated in FIG. 7. As a result, the stripping using the strips 1 and 110 for stripping the tooth of the present embodiment helps to maintain the aesthetics according to the preservation of the tooth shape when the orthodontics are performed to induce a change in the position of the tooth after stripping.

Hereinabove, the embodiments of the present invention have been described with the accompanying drawings, but it can be understood by those skilled in the art that technical configurations of the present invention can be executed in other detailed forms without changing the technical spirit or requisite features of the present invention. Therefore, it should be appreciated that the aforementioned embodiments are illustrative in all aspects and are not restricted. In addition, the scope of the present invention is indicated by the appended claims to be described below rather than the detailed description above. Further, it is to be understood that all changes or modifications derived from the meaning and scope of the appended claims and equivalent concepts thereof are included in the scope of the present invention.

What is claimed is:

1. A 3-dimentional strip for stripping a tooth, wherein some or whole of at least one side of both sides includes an abrasive face to abrade an interdental area, an upper portion includes a predetermined thickness along a longitudinal direction, and a lower portion includes a thickness decreased toward an end of the longitudinal direction and increased toward the other end of the longitudinal direction, wherein the thickness on the other end is greater than the thickness of the upper portion.

2. The 3-dimentional strip for stripping the tooth of claim 1, wherein the upper portion and the lower portion are connected to each other continuously in a height direction and the lower portion is formed up to ¼ to ¾ of the entire height from a lower end thereof.

3. The 3-dimentional strip for stripping the tooth of claim 1, wherein a longitudinal section of the other end includes a concavely curved outline.

4. The 3-dimentional strip for stripping the tooth of claim 1, wherein the thickness of the upper portion is 0.05 mm to 0.2 mm and the thickness of the lower portion is 0.05 mm to 0.3 mm at the other end.

5. A tooth stripping device comprising:
a 3-dimentional strip for stripping a tooth, wherein some or whole of at least one side of both sides includes an abrasive face to abrade an interdental area, an upper portion includes a predetermined thickness along a longitudinal direction, and a lower portion includes a thickness decreased toward an end of the longitudinal direction and increased toward the other end of the longitudinal direction, wherein the thickness on the other end is greater than the thickness of the upper portion;
a strip holder coupled to both ends of the strip for stripping the tooth; and
a handpiece coupled to one end of the strip holder.
